(19) United States
(12) Patent Application Publication
(10) Pub. No.: US 2016/0201660 A1
(43) Pub. Date: Jul. 14, 2016

(54) A FLUID CYLINDER

(71) Applicant: DONGGUAN RICHTEK ELECTRONICS CO.,LTD., Dongguan, Guangdong (CN)

(72) Inventor: Qi YANG, Dongguan, guangdong (CN)

(21) Appl. No.: 14/914,107

(22) PCT Filed: Jun. 10, 2014
(86) PCT No.: PCT/CN2014/079606

§ 371 Date: Feb. 24, 2016

(30) Foreign Application Priority Data
Aug. 30, 2013 (CN) 201310385456.X
Aug. 30, 2013 (CN) 201320534101.8

(51) Int. Cl. F04B 39/00; F16J 1/00; F04B 39/12; F16J 10/02

(52) U.S. Cl. CPC F04B 39/0005; F16J 10/02; F16J 1/008; F04B 39/12

(57) ABSTRACT

A fluid cylinder comprises a cylinder tube having a first tube end and a second tube end with respect to a tube axis of the cylinder tube, wherein the tube axis refers to the axis of the cylinder tube and the extension of the axis; an opening arranged at the first tube end for allowing fluid to enter into the cylinder tube; a piston; a sealing member arranged on the piston and adapted to provide a fluid-tight sealing between the piston and an inner wall of the cylinder tube; and a driving member adapted to drive the piston to perform a piston motion in the cylinder tube along the tube axis, wherein the cylinder tube, the opening, the piston, the sealing member, the inner wall and the driving member are adapted.

### CROSS-REFERENCE TO RELATED APPLICATIONS

The preset application claims the priority of Chinese patent applications CN201310385456.X and CN201320534101.8, which are herein incorporated by reference for all that they teach without exclusion of any part thereof.

### FIELD OF THE INVENTION

The present disclosure relates to a cylinder for fluid with fluid inlet means, in particular to a gas cylinder with gas inlet means.

### BACKGROUND OF THE INVENTION

A conventional cylinder for fluid comprises means for allowing fluid to enter into the cylinder, which is normally a fluid inlet valve, in particular a unidirectional valve. The fluid outside the cylinder can enter into the cylinder through such an inlet valve but the fluid inside the cylinder cannot flow out of the cylinder through such an inlet valve.

### SUMMARY OF THE INVENTION

A fluid cylinder comprises a cylinder tube having a first tube end and a second tube end with respect to a tube axis of the cylinder tube, wherein the tube axis refers to the axis of the cylinder tube and the extension of the axis; an opening arranged at the first tube end for allowing fluid to enter into the cylinder tube; a piston; a sealing member arranged on the piston and adapted to provide a fluid-tight sealing between the piston and an inner wall of the cylinder tube; and a driving member adapted to drive the piston to perform a piston motion in the cylinder tube along the tube axis, wherein the cylinder tube, the opening, the piston, the sealing member, the inner wall and the driving member are adapted, when the piston is driven to move in a first axial direction, to remove at least a part of the fluid-tight sealing for allowing fluid to enter into the cylinder tube through the opening, wherein the first axial direction is an axial direction from the second tube end towards the first tube end along the tube axis.

### BRIEF DESCRIPTION OF THE DRAWINGS

The drawings are used merely for illustration purposes but not for limiting the scope of the protection.

FIG. 1 shows a schematic view of the fluid cylinder;

FIG. 2a-2d show a configuration of the fluid cylinder in the first embodiment;

FIG. 3 shows an alternative in the first embodiment;

FIG. 4 shows a further alternative in the first embodiment;

FIG. 5 shows a further alternative in the first embodiment;

FIG. 6a-6i show a further alternative in the first embodiment;

FIG. 7a-7b show further alternatives in the first embodiment;

FIG. 8 shows a configuration of the fluid cylinder in the second embodiment; and

FIG. 9a-9b show configurations of the fluid cylinder in the third embodiment.

### DETAILED DESCRIPTION OF THE PREFERRED EMBODIMENTS

A conventional unidirectional fluid inlet valve for a cylinder can be designed to work with excellent unidirectional property, but with the costs of relative expensive components and large size.

A cheap and small-sized unidirectional fluid inlet valve is however not excellent in the unidirectional property. That is, the fluid may leak out of the cylinder through the fluid inlet valve.

The present invention provides a fluid cylinder with special fluid inlet means.

The fluid cylinder comprises a cylinder tube having a first tube end and a second tube end with respect to a tube axis of the cylinder tube, wherein the tube axis refers to the axis of the cylinder tube and the extension of the axis; an opening arranged at the first tube end for allowing fluid to enter into the cylinder tube; a piston; a sealing member arranged on the piston and adapted to provide a fluid-tight sealing between the piston and an inner wall of the cylinder tube; and a driving member adapted to drive the piston to perform a piston motion in the cylinder tube along the tube axis, wherein the cylinder tube, the opening, the piston, the sealing member, the inner wall and the driving member are adapted, when the piston is driven to move in a first axial direction, to remove at least a part of the fluid-tight sealing for allowing fluid to enter into the cylinder tube through the opening, wherein the first axial direction is an axial direction from the second tube end towards the first tube end along the tube axis.

There are at least three basic embodiments to remove at least a part of the fluid-tight sealing for allowing fluid to enter into the cylinder tube through the opening:

(1) The driving member may be adapted, upon driving the piston to move in the first axial direction, to drive the piston towards a first radial side of the piston in a first radial direction to remove the fluid-tight sealing on a second radial side of the piston opposing to the first radial side of the piston, wherein the first radial direction is a radial direction perpendicular to the tube axis;

(2) The cylinder tube may comprise an expanded part arranged at the first tube end and at least a part of the inner wall of the expanded part is expanded in a radial direction perpendicular to the tube axis, and the driving member may be adapted to drive the piston in the first axial direction to reach the expanded part so as to remove at least a part of the fluid-tight sealing; and

(3) The first tube end and the sealing member may be adapted, when the piston is driven to the first tube end, to enable at least a part of the sealing member to be outside of the cylinder tube so as to remove at least a part of the fluid-tight sealing.

In above embodiment (1), the driving member may be adapted, upon driving the piston to move in a second axial direction opposing to the first axial direction, to drive the piston towards the second radial side of the piston in a second radial direction opposing to the first radial direction and to maintain the fluid-tight sealing on the first radial side and the second radial side of the piston.

The cylinder tube may have a tube cross section that is perpendicular to the tube axis, the piston may have a piston cross section that is parallel with the tube cross section when the piston is not driven along any radial direction, at least a part of the sealing member on the second radial side of the piston may be arranged in an inclined piston cross section inclining towards the first axial direction to form a first angle α with the piston cross section, wherein the first angle α is in a reference plane that is along the first radial direction and perpendicular to the tube cross section, the driving member may be adapted, upon driving the piston towards the first radial side of the piston, to move the second radial side of the piston (30) more in the first axial direction than the first radial side of the piston so that the piston cross section tilts towards the first axial direction to form a second angle β1 with the tube cross section in the reference plane and the inclined piston cross section forms a third angle γ1 with the tube cross section in the reference plane, wherein γ1=α+β1, and the driving member may be adapted, upon driving the piston towards the second radial side of the piston, to move the second radial side of the piston more in the second axial direction than the first radial side of the piston so that the piston cross section tilts towards the second axial direction to form a fourth angle β2 with the tube cross section in the reference plane and the inclined piston cross section forms a fifth angle γ2 with the tube cross section in the reference plane, wherein β2=α−β2.

The first angle α, a maximum of the second angle β1ₘₐₓ, and a maximum of the fourth angle β2ₘₐₓ may be adapted to fulfil the following equations:

γ1ₘₐₓ=α+β1ₘₐₓ, (1)

|γ2|ₘₐₓ=max(|α−β2ₘₐₓ|,α), (2)

βₘₐₓ=(β1ₘₐₓ−β2ₘₐₓ)/2, (3)

1.5·βₘₐₓ−x°≦γ1ₘₐₓ≦1.5·βₘₐₓ+x°, (4)

0.5·βₘₐₓ−x°≦|β2|ₘₐₓ≦0.5·βₘₐₓ+x°, (5)

wherein x° is a first prescribed value which is a positive value being equal to or smaller than 0.5·βₘₐₓ and smaller than 5°, preferably smaller than 4°, more preferably smaller than 3°, in particular preferably smaller than 2°, more particular preferably smaller than 1°.

The maximum of the second angle β1ₘₐₓ and the maximum of the fourth angle β2ₘₐₓ may be adapted to fulfil

βₘₐₓ=y°, (6)

wherein y° is a second prescribed value being in a range of from 5° to 15°, preferably 7° to 13°, more preferably 9° to 11°, and further more preferably 9.4° to 10.6°.

The driving member may comprise a piston rod, the piston rod may comprise a first rod end coupled to the piston, the piston rod may extend from the first rod end in the first axial direction and terminate at a second rod end, the second rod end may be adapted to move along a closed orbit so as to drive the piston to fulfil equations (1) to (6), the closed orbit extending in both the axial direction and the radial direction, the closed orbit has a first outmost point in the first radial direction R1 in view of the tube axis and a second outmost point in the second radial direction in view of the tube axis, and the maximum of the second angle β1ₘₐₓ is formed when the second rod end arrives at the first outmost point, while the maximum of the fourth angle β2ₘₐₓ is formed when the second rod end arrives at the second outmost point.

The closed orbit may be located within the reference plane.

The driving member may comprise a rotatable member coupled to the second rod end, and the rotatable member may be adapted to rotate so as to move the second rod end along the closed orbit.

The rotatable member may be adapted to form the closed orbit in a circular shape.

The circle center of the closed orbit may be arranged on the tube axis, and the first angle α is larger than 0°.

The circle center of the closed orbit may be arranged to shift from the tube axis in the first radial direction.

The rotatable member may be a gear set driven by a motor, or the rotatable member may be a rotatable rod driven by a motor.

The rotable member may be adapted to form the closed orbit in a non-circular shape.

In any of above embodiments (1), (2) and (3), the second tube end may be a closed end and provided with a fluid outlet valve, wherein the fluid outlet valve may be a unidirectional valve for releasing fluid to the outside of the cylinder tube. The fluid cylinder may be a gas cylinder and the fluid-tight sealing may be a gas-tight sealing.

The fluid cylinder may be a gas cylinder, the fluid-tight sealing may be a gas-tight sealing, and the fluid outlet valve may be a gas outlet valve.

The gas cylinder may be used in a gas compressor.

### EMBODIMENTS

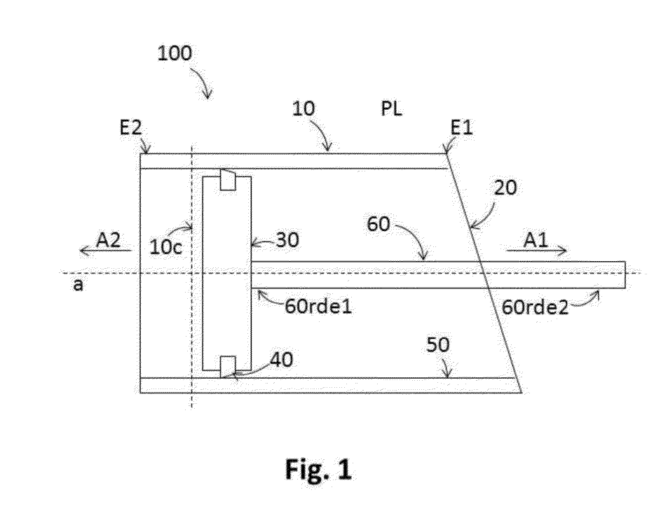

FIG. 1 shows a longitudinal section of a fluid cylinder 100 along the axis of a cylinder tube 10 of the fluid cylinder 100. The fluid cylinder 100 can be used for liquid such as water or for gas such as air.

The cylinder tube 10 is normally in a standard cylinder shape with a straight tube axis a and a tube cross section 10c perpendicular to the tube axis a being in a circular shape, wherein the tube axis a refers not only to the axis of the cylinder tube but also to the extension thereof.

However, the cylinder tube 10 is not limited to a standard cylinder shape, as long as all the functions of the fluid cylinder 100 of the present invention can be realized. For example, a tube cross section 10c of the cylinder tube 10 perpendicular to the tube axis a may also be in other shapes such as an ellipse, the cylinder tube 10 may be slightly curved along its tube axis a, and/or an end of the cylinder tube 10 may have an end face not parallel with the tube cross section 10c.

The longitudinal section of the fluid cylinder 100 as shown in FIG. 1 is located in a reference plane PL, which extends along the tube axis a and is perpendicular to the tube cross section 10c.

The cylinder tube 10 has a first tube end E1 and a second tube end E2. The first tube end E1 includes an opening 20 for allowing fluid to enter into the cylinder tube 10. The first tube end E1 may have an inclined flat cross section as shown in FIG. 1, but may also be in other shapes, such as a flat cross section perpendicular to the tube axis a, a curved shape, etc. Similarly, the second tube end E2 is also not limited to the shape shown in FIG. 1. The shapes of the first and second tube ends E1 and E2 can be any possible shapes as long as the functions of the fluid cylinder 100 of the present invention can be achieved.

The opening 20 may be a complete opening in view of the tube cross section 10c of the cylinder tube 10. However, the opening 20 may also be in any other shape as long as the functions of the fluid cylinder 100 of the present invention can be achieved.

The fluid cylinder 100 comprises a piston 30, which can be driven by a driving member 60 to perform a piston motion in the cylinder tube 10 in an axial direction along the tube axis a. The driving member 60 is not limited to the rod-shape as shown in FIG. 1. It can be any other shape, such as a curved rod. Further, the first rod end 60rde1 is not necessarily coupled to the radial center of the piston 30. The shape and the coupling position of the driving member 60 can be designed in various manners, as long as the functions of the fluid cylinder 100 of the present invention can be achieved.

A sealing member 40 is arranged on the piston 30 for providing fluid-tight sealing between the piston 30 and an inner wall 50 of the cylinder tube 10. The shape of the cross section of the sealing member 40 in FIG. 1 is in a trapezoid shape. However, the shape of this cross section is not limited thereto. It can be other shapes, such as a circle, an ellipse, a triangle, or any other proper shapes. The sealing member 40 is preferably arranged to be fitted into a groove around the piston 30, to increase the robustness of the fitting between the piston 30 and the sealing member 40.

The fluid-tight sealing does not refers to absolute sealing without any leakage, since it is not possible to realize absolute sealing. Instead, the fluid-tight sealing refers to a substantial sealing with respect to the fluid to be used in the fluid cylinder 100 and the purpose of the fluid cylinder 100. For example, when the fluid cylinder 100 is an air cylinder used in an air compressor, the fluid-tight sealing is an air-tight sealing which can guarantee to produce the air pressure required by the air compressor.

When the driving member 60 drives the piston 30 to move in a first axial direction A1 towards the first tube end E1, the fluid cylinder 100 is adapted to remove at least a part of the fluid-tight sealing provided by the sealing member 40, so that fluid can enter into the cylinder tube 10 through the opening 20.

There are least three various embodiments for removing at least a part of the fluid-tight sealing provided by the sealing member 40.

### The First Embodiment

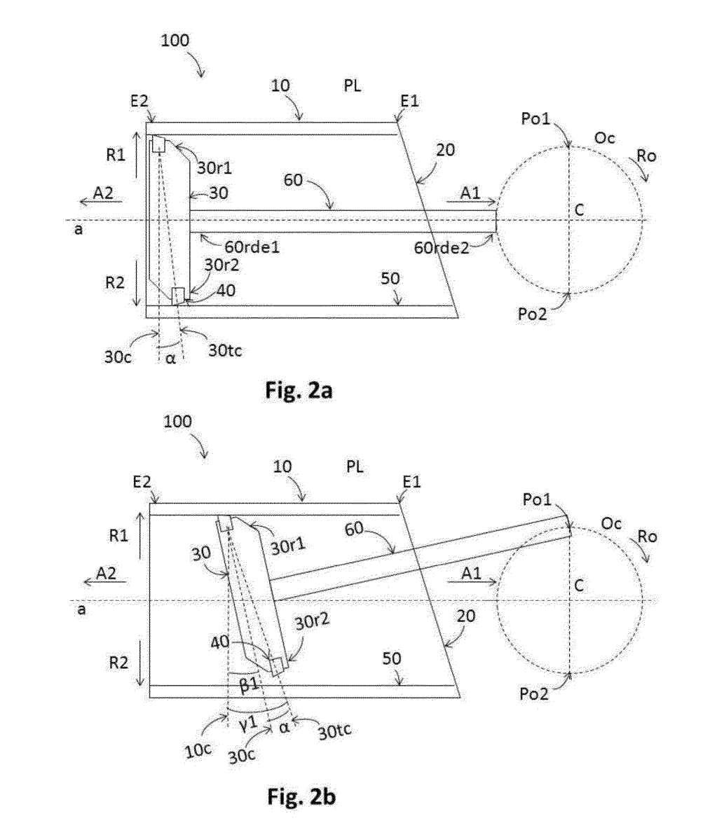

FIGS. 2-7 show the first embodiment for removing at least a part of the fluid-tight sealing.

The driving member 60 is adapted, upon driving the piston 30 to move in the first axial direction A1, to drive the piston 30 towards a first radial side 30r1 of the piston 30 in a first radial direction R1 in the reference plane PL, so that the fluid-tight sealing on a second radial side 30r2 of the piston 30 is removed for allowing fluid to enter into the cylinder tube 10.

Further, the driving member 60 is also adapted to, upon driving the piston 30 to move in the second axial direction A2, to drive the piston 30 towards the second radial side 30r2 along a second radial direction R2 in the reference plane PL, but the fluid-tight sealing on both the first and second radial sides 30r1, 30r2 is not removed. That is, the entire fluid-tight sealing is maintained and thus the fluid entered into the cylinder tube 10 is driven by the piston 30 towards the second axial direction A2.

As shown in FIG. 2a-2d, the piston 30 has a piston cross section 30c perpendicular to the tube axis a when the piston 30 is not driven by the driving member 60 in any radial direction perpendicular to the tube axis a. The sealing member 40 is formed in an inclined piston cross section 30tc of the piston 30, which forms with the piston cross section 30c a first angle α in the reference plane PL. The first angle α is normally larger than 0°, but can also be 0°, which means that the inclined piston cross section 30tc is not inclined but parallel with the piston cross section 30c. In a special case, the first angle α may even be of a negative value, which will be described later.

As shown in FIG. 2b, the driving member 60 is adapted, upon driving the piston 30 towards the first radial side 30r1 of the piston 30, to move the second radial side 30r2 of the piston 30 more in the first axial direction A1 than the first radial side 30r1 of the piston 30 so that the piston cross section 30c tilts towards the first axial direction A1 to form a second angle β1 with the tube cross section 10c in the reference plane PL and the inclined piston cross section 30tc forms a third angle γ1 with the tube cross section 10c in the reference plane PL, wherein γ1=α+β1.

The second angle β1 can be varied when the piston 30 is driven to move in the first axial direction A1.

On the other hand, as shown in FIG. 2d, the driving member 60 is adapted, upon driving the piston 30 towards the second radial side 30r2 of the piston 30, to move the second radial side 30r2 of the piston 30 more in the second axial direction R2 than the first radial side 30r1 of the piston 30 so that the piston cross section 30c tilts towards the second axial direction A2 to form a fourth angle β2 with the tube cross section 10c in the reference plane PL and the inclined piston cross section 30tc forms a fifth angle γ2 with the tube cross section 10c in the reference plane PL, wherein β2=α−β2.

The fourth angle β2 can be varied when the piston 30 is driven to move in the second axial direction A2.

The fourth angle β2 and the first angle α can render the fifth angle γ2 to be of a positive value. The fourth angle β2 and the first angle α can also render the fifth angle γ2 to be of a negative value.

The first angel α, a maximum of the second angle β1ₘₐₓ, and a maximum of the fourth angle β2ₘₐₓ are adapted to fulfil the following equations:

γ1ₘₐₓ=α+β1ₘₐₓ, (1)

|γ2|ₘₐₓ=max(|α−β2ₘₐₓ|,α), (2)

βₘₐₓ=(β1ₘₐₓ−β2ₘₐₓ)/2, (3)

1.5·βₘₐₓ−x°≦γ1ₘₐₓ≦1.5·βₘₐₓ+x°, (4)

0.5·βₘₐₓ−x°≦|β2|ₘₐₓ≦0.5·βₘₐₓ+x°, (5)

wherein x° is a first prescribed value which is a positive value being equal to or smaller than 0.5·βₘₐₓ and smaller than 5°, preferably smaller than 4°, more preferably smaller than 3°, in particular preferably smaller than 2°, more particular preferably smaller than 1°.

With equations (1) to (5), |γ2|ₘₐₓ can be adjusted so that the fluid-tight sealing is substantially not removed at any sides of the piston 30 when the piston 30 is driven to move in the second axial direction A2, so as to push the fluid entered into the cylinder tube 10 in the second axial direction A2. At the same time, γ1ₘₐₓ is adjusted to be large enough for allowing enough fluid to enter into the cylinder tube 10 when the piston 30 is driven to move in the first axial direction A1. That is, equations (1) to (5) achieve a good balance between the amount of fluid that can enter into the cylinder tube 10 and the fluid-tight sealing for pushing the fluid in the cylinder tube 10.

The maximum of the second angle β1ₘₐₓ and the maximum of the fourth angle β2ₘₐₓ are adapted to fulfil

βₘₐₓ=y°, (6)

wherein y° is a second prescribed value. The second prescribed value y° is an empirical value for further improving the balance between the amount of fluid that can enter into the cylinder tube 10 and the fluid-tight sealing for pushing the fluid in the cylinder tube 10. The second prescribed value y° may be in a range of from 5° to 15°, preferably 7° to 13°, more preferably 9° to 11°, and further more preferably 9.4° to 10.6°.

The second prescribed value y° may also be slightly varied depending on the shape of the cross section of the sealing member 40, since the fluid-tight sealing provided by the sealing member 40 depends on the shape of the cross section of the sealing member 40 and the inclination angle of the sealing member 40 with respect to the inner wall 50 of the cylinder tube 10. Further, the second prescribed value y° may also be affected by the material of the sealing member 40, the hardness of the sealing member 40 and the pressure between the sealing member 40 and the inner wall 50 of the cylinder tube 10.

As shown in FIGS. 2a-2d, the first radial side 30r1 and the second radial side 30r2 may be chamfered on the respective sides of the sealing member 40, to avoid collision between the piston 30 and the inner wall 50 of the cylinder tube 10, when the piston 30 is tilted by the driving member 60.

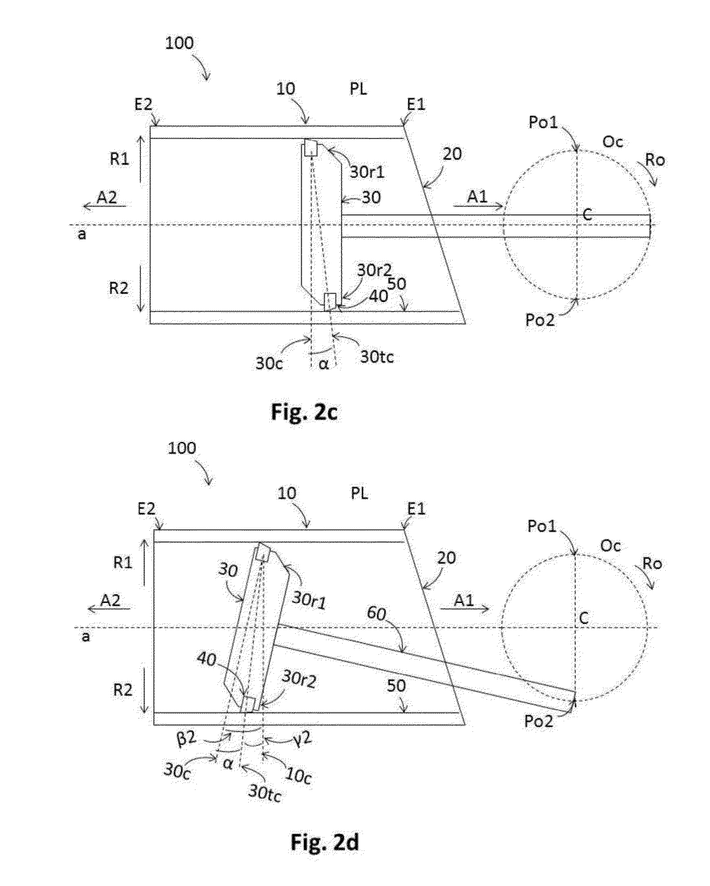

Further, it is not necessary that the entire sealing member is located in the inclined piston cross section 30tc. It is also feasible that only a part of sealing member is inclined, for example, as shown FIG. 3, by which the same function shown in FIGS. 2a-2d can also be achieved.

As shown in FIGS. 2a-2d, the driving member 60 may comprise a piston rod with a first rod end 60rde1 and a second rod end 60rde2. The first rod end 60rde1 is coupled to the piston 30. The second rod end 60rde2 is adapted to move along a closed orbit Oc. The closed orbit Oc extends in both the axial direction and the radial direction, so that the piston 30 is driven to move along the first and second axial directions A1, A2, to move the piston 30 towards the first and second radial direction R1, R2, and to tilt the piston 30.

The closed orbit (Oc) has a first outmost point Po1 in the first radial direction R1 in view of the tube axis a and a second outmost point Po2 in the second radial direction R2 in view of the tube axis a.

The maximum of the second angle β1ₘₐₓ is formed when the second rod end 60rde2 arrives at the first outmost point (Po1), while the maximum of the fourth angle β2ₘₐₓ is formed when the second rod end 60rde2 arrives at the second outmost point (Po2).

The closed orbit Oc may be located entirely within the reference plane PL. The driving member 60 may comprises a rotatable member 60rm coupled to the second rod end 60rde2 of the piston rod 60rd and the rotatable member 60rm is adapted to rotate so as to move the second rod end 60rde2 along the closed orbit Oc, preferably only in the rotating direction Ro as shown in FIGS. 2-7.

The closed orbit Oc is preferably in a circular shape as shown in FIGS. 2-6.

The circle center C of the closed orbit Oc may be arranged on the tube axis a, as shown in FIGS. 2-3 and 5-6. In this case, the first angle α should be larger than 0°, so that it is possible to fulfil the conditions defined by equations (1)-(6).

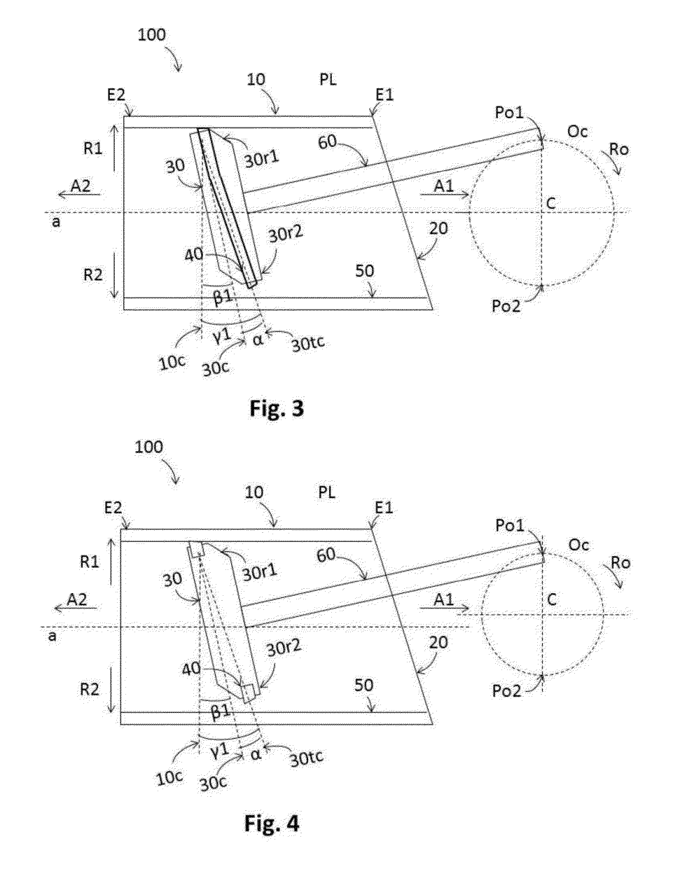

The circle center C of the closed orbit Oc may also be arranged to shift from the tube axis a in the first radial direction R1, as shown in FIG. 4. In this case, the maximum of the second angle β1ₘₐₓ is larger than the maximum of the fourth angle β2ₘₐₓ. Thus, the first angle α may be reduced and even can be 0°, while the conditions defined by equations (1)-(6) can still be fulfilled. In a non-preferable but still feasible embodiment, the first angle α may even be of a negative value and equations (1)-(6) can still be fulfilled as long as the second angle β1ₘₐₓ is enough larger than the maximum of the fourth angle β2ₘₐₓ.

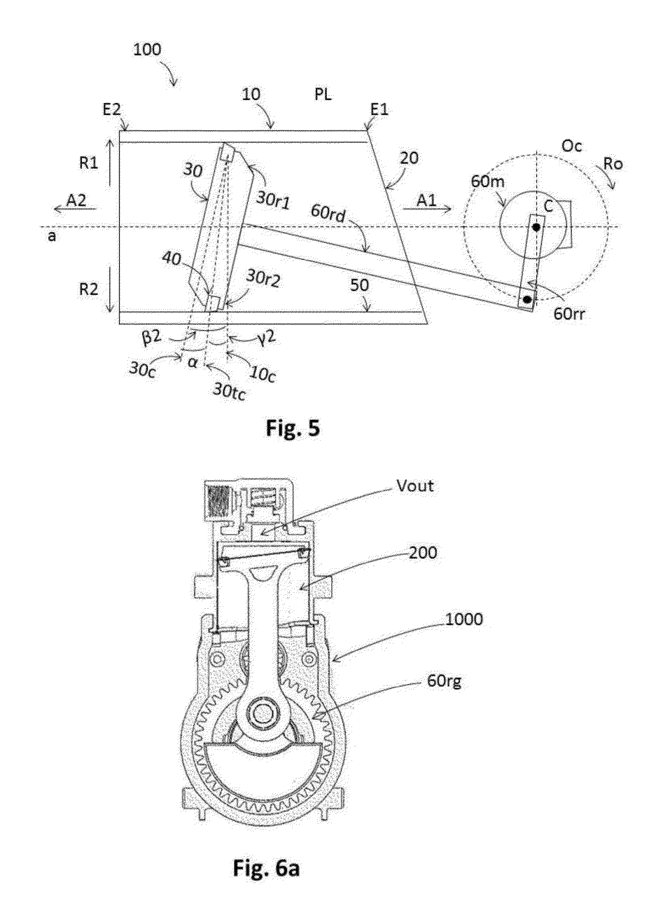

When the closed orbit Oc is in a circular shape, the rotatable member 60rm can be a rotatable rod 60rr driven by a motor 60m, as shown in FIG. 5. One end of the rotatable rod 60rr is coupled to the second rod end 60rde2 of the piston rod 60rd and the other end of the rotatable rod 60rr is arranged to be driven by the motor 60m at the circle center C. The rotatory shaft of the motor 60m can be directly coupled to the other end of the rotatable rod 60rr at the circle center C, and can also be coupled thereto through other means, such as a gear set, a gear-and-chain set, etc.

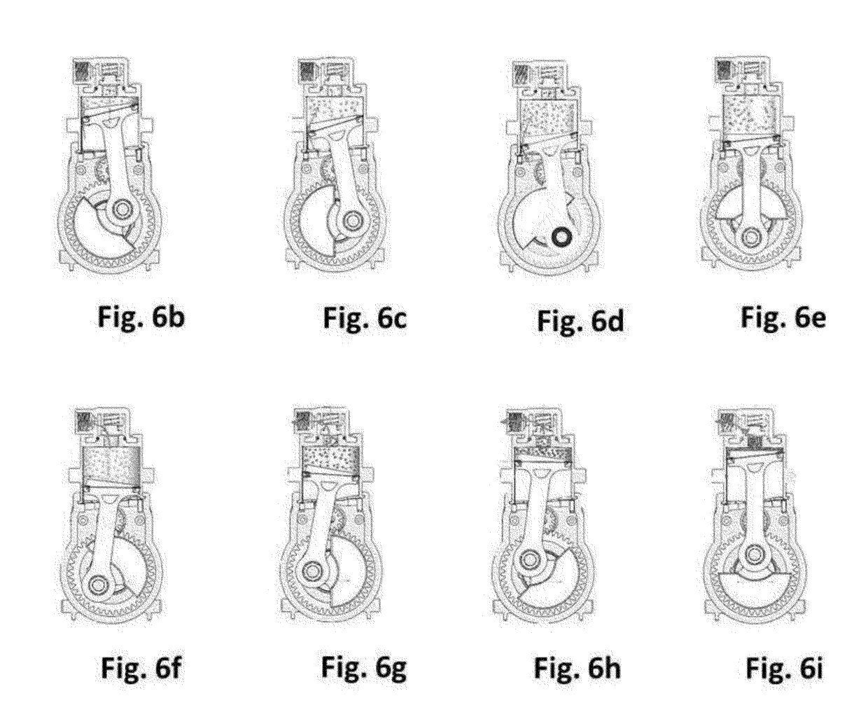

When the closed orbit Oc is in a circular shape, the rotatable member 60rm can also be a gear set 60rg driven by a motor 60m, as shown in FIGS. 6a-6h. FIGS. 6a-6h show a preferred embodiment with individual steps when the piston 30 is driven to remove the fluid-tight sealing for allowing fluid to enter, and to close the fluid-tight sealing for pushing the fluid in the second axial direction A2.

In particular, FIGS. 6a-6i show that the fluid cylinder 100 may be a gas cylinder 200 used in a gas compressor 1000 with gas outlet valve Vout at the second tube end E2 for releasing gas out of the cylinder tube 10. In this case, the gas outside the gas cylinder 200 can enter into the cylinder tube 10 through gas inlet means by removing at least a part of the gas-tight sealing between the piston 30 and the inner wall 50 of the cylinder tube 10. Then, the gas is pushed and compressed by the piston 30 so as to flow out of the cylinder tube 10 through the gas outlet valve Vout then into for example a compressed gas storage container or a tire of a vehicle which uses compressed gas such as air.

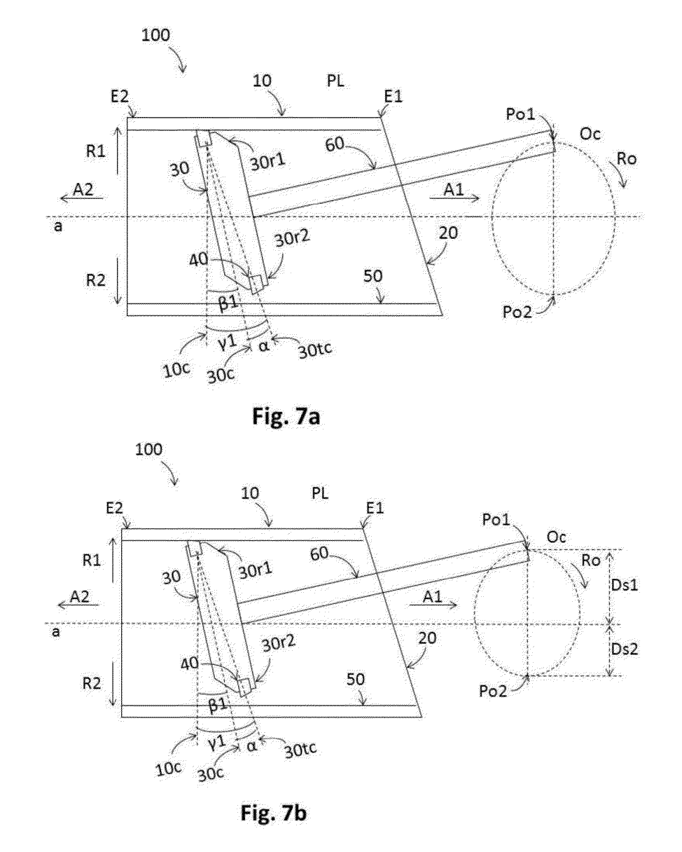

The closed orbit Oc may also be in other shapes realized by any proper mechanical rotating means which can produce non-circular closed rotating orbit. For example, FIGS. 7a and 7b show elliptical closed orbits.

The elliptical closed orbit Oc in FIG. 7a is symmetric with respect to the tube axis a, and in this case it is required that the first angle α is larger than 0°, so that it is possible to fulfil the conditions defined by equations (1)-(6). The elliptical closed orbit Oc in FIG. 7a has a longer axis in the radial direction than the axis in the axial direction, which can shorten the moving distance of the piston 30 in the axial direction. In contrast, it is also possible to use an elliptical closed orbit with a longer axis in the axial direction to enlarge the moving distance of the piston 30 in the axial direction, depending on the need of the fluid-cylinder.

In FIG. 7b, the elliptical closed orbit is shifted in the first radial direction R1, which is similar to the situation shown in FIG. 4. In this case, the first angle α may be reduced, or even may be equal to or smaller than 0°, as long as the conditions defined in equations (1)-(6) can be fulfilled.

### The Second Embodiment

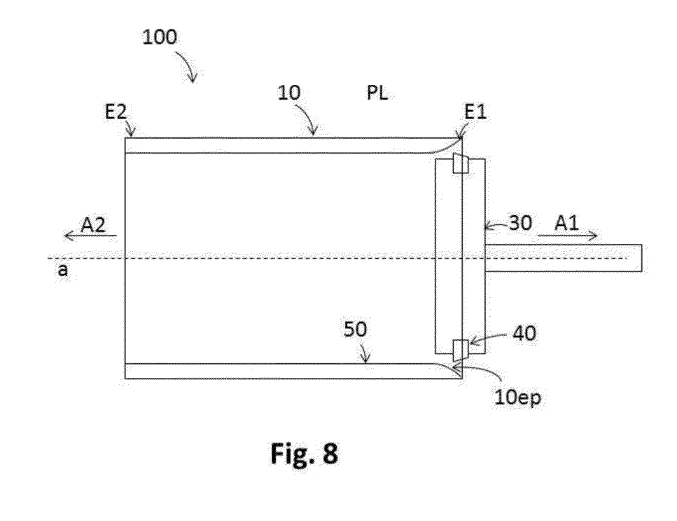

The second embodiment for removing at least a part of the fluid-tight sealing lies in an expanded part 10ep arranged at the first tube end E1 of the cylinder tube 10, as shown in FIG. 8. In the expanded part 10ep, at least a part of the inner wall 50 of the cylinder tube 10 is expanded in a radial direction perpendicular to the tube axis a. As a result, when the piston 30 is driven in the first axial direction A1 and reaches the expanded part 10ep, at least a part of the fluid-tight sealing is removed due to the at least a part of the expanded inner wall, so that fluid such as water or gas can flow into the cylinder tube 10. When the piston 30 is driven back in the second axial direction A2 and moves out of the expanded part 10ep, the fluid-tight sealing is resumed and thus the fluid entered into the cylinder tube 10 is pushed by the piston 30 in the second axial direction A2.

The expanded inner wall may extend throughout the expanded part 10ep in its circumferential direction. Alternatively, the inner wall 50 in the expanded part 10ep can be provided with one or more grooves extending in the axial direction, so that only a part of the inner wall 50 in the expanded part 10ep is expanded in the radial direction.

### The Third Embodiment

The third embodiment for removing at least a part of the fluid-tight sealing lies in that when the piston 30 is driven to the first tube end E1 of the cylinder tube 10, at least a part of the sealing member 40 is driven to be outside of the cylinder tube 10 so as to remove at least a part of the fluid-tight sealing.

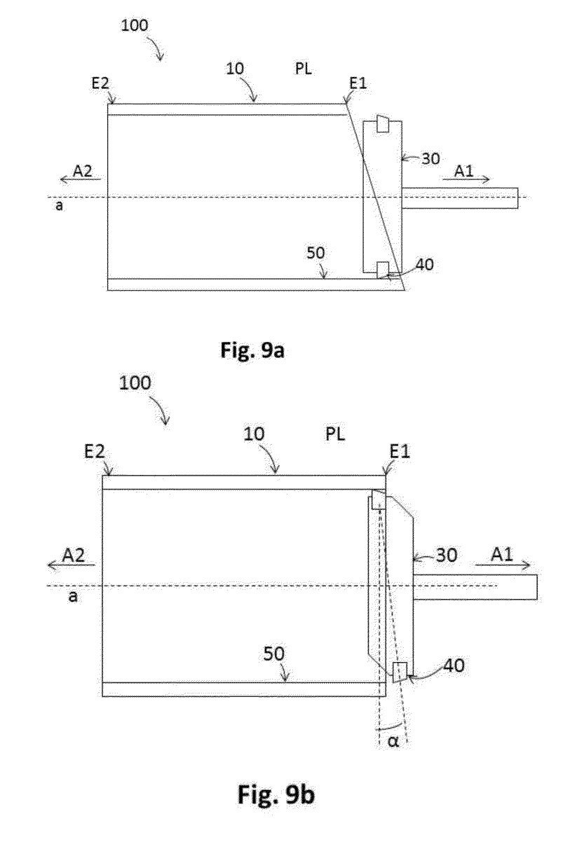

For example, FIG. 9a shows a cylinder tube 10 having an opening at the first tube end E1 with a flat inclined face. As a result, when the piston 30 reaches the first tube end E1, the upper part of the sealing member 40 as shown in FIG. 9a is outside of the cylinder tube 10, so that the fluid-tight sealing is removed for allowing fluid to enter into the cylinder tube 10. When the piston 30 is driven back in the second axial direction A2, the sealing member 40 returns into the cylinder tube 10 and thus the fluid-tight sealing is resumed and the fluid is pushed in the second axial direction by the piston 30.

Alternatively, the opening at the first tube end E1 may be arranged to be a flat face perpendicular to the tube axis a, while the sealing member 40 may be placed in an inclined cross section, as shown in FIG. 9b. This alternative can achieve the same effect as the one shown in FIG. 9a.

Further, other alternatives may also work, as long as the face of the opening at the first tube end E1 and the cross section of the sealing member 40 do not match with one another. For example, the face of the opening can be a curved face whereas the cross section of the sealing member is flat, or the other way around. For a further example, the face of the opening and the cross section of the sealing member can both be arranged in a curved shape but they do not match with one another. In this way, when the piston reaches the opening at the first tube end E1, at least a part of the sealing member 40 will be out of the cylinder tube 10 to remove the fluid-tight sealing.

In the second and third embodiments, the driving member 60 may drive the piston 30 only in the first and second axial directions A1, A2 without any driven force towards any radial direction.

The above three embodiments for removing at least a part of the fluid-tight sealing are not contradictory to each other, and thus can be combined in appropriate manners.

The above description is only the preferred embodiments of the present disclosure and is not intended to limit the scope of the protection. Any modification, equivalent substitution and improvement made within the principle of the present disclosure as defined in the appended claims should be covered by the protection scope of the invention.

1. A fluid cylinder (100), comprising:
a cylinder tube (10) having a first tube end (E1) and a second tube end (E2) with respect to a tube axis (a) of the cylinder tube (10), wherein the tube axis (a) refers to the axis of the cylinder tube (10) and the extension of the axis;
an opening (20) arranged at the first tube end (E1) for allowing fluid to enter into the cylinder tube (10);
a piston (30);
a sealing member (40) arranged on the piston (30) and adapted to provide a fluid-tight sealing between the piston (30) and an inner wall (50) of the cylinder tube (10); and
a driving member (60) adapted to drive the piston (30) to perform a piston motion in the cylinder tube (10) along the tube axis (a),
wherein the cylinder tube (10), the opening (20), the piston (30), the sealing member (40), the inner wall (50) and the driving member (60) are adapted, when the piston (30) is driven to move in a first axial direction (A1), to remove at least a part of the fluid-tight sealing for allowing fluid to enter into the cylinder tube (10) through the opening (20), wherein the first axial direction (A1) is an axial direction from the second tube end (E2) towards the first tube end (E1) along the tube axis (a).

2. The fluid cylinder (100) of claim 1, wherein
the driving member (60) is adapted, upon driving the piston (30) to move in the first axial direction (A1), to drive the piston (30) towards a first radial side (30r1) of the piston (30) in a first radial direction (R1) to remove the fluid-tight sealing on a second radial side (30r2) of the piston (30) opposing to the first radial side (30r1) of the piston (30), wherein the first radial direction (R1) is a radial direction perpendicular to the tube axis (a).

3. The fluid cylinder (100) of claim 2, wherein
the driving member (60) is adapted, upon driving the piston (30) to move in a second axial direction (A2) opposing to the first axial direction (A1), to drive the piston (30) towards the second radial side (30r2) of the piston (30) in a second radial direction (R2) opposing to the first radial direction (R1) and to maintain the fluid-tight sealing on the first radial side (30r1) and the second radial side (30r2) of the piston (30).

4. The fluid cylinder (100) of claim 3, wherein
the cylinder tube (10) has a tube cross section (10c) that is perpendicular to the tube axis (a),
the piston (30) has a piston cross section (30c) that is parallel with the tube cross section (10c) when the piston (30) is not driven along any radial direction,
at least a part of the sealing member (40) on the second radial side (30r2) of the piston (30) is arranged in an inclined piston cross section (30tc) inclining towards the first axial direction (A1) to form a first angle α with the piston cross section (30c), wherein the first angle α is in a reference plane (PL) that is along the first radial direction (A1) and perpendicular to the tube cross section (10c),
the driving member (60) is adapted, upon driving the piston (30) towards the first radial side (30r1) of the piston (30), to move the second radial side (30r2) of the piston (30) more in the first axial direction (A1) than the first radial side (30r1) of the piston (30) so that the piston cross section (30c) tilts towards the first axial direction (A1) to form a second angle β1 with the tube cross section (10c) in the reference plane (PL) and the inclined piston cross section (30tc) forms a third angle γ1 with the tube cross section (10c) in the reference plane (PL), wherein γ1=α+β1, and
the driving member (60) is adapted, upon driving the piston (30) towards the second radial side (30r2) of the piston (30), to move the second radial side (30r2) of the piston (30) more in the second axial direction (R2) than the first radial side (30r1) of the piston (30) so that the piston cross section (30c) tilts towards the second axial direction (A2) to form a fourth angle β2 with the tube cross section (10c) in the reference plane (PL) and the inclined piston cross section (30tc) forms a fifth angle γ2 with the tube cross section (10c) in the reference plane (PL), wherein β2=α−β2.

5. The fluid cylinder (100) of claim 4, wherein
the first angel α, a maximum of the second angle β1ₘₐₓ, and a maximum of the fourth angle β2ₘₐₓ are adapted to fulfil the following equations:
γ1ₘₐₓ=α+β1ₘₐₓ, (1)

|γ2|ₘₐₓ=max(|α−β2ₘₐₓ|,α), (2)
βₘₐₓ=(β1ₘₐₓ−β2ₘₐₓ)/2, (3)
1.5·βₘₐₓ−x°≦γ1ₘₐₓ≦1.5·βₘₐₓ+x°, (4)
0.5·βₘₐₓ−x°≦|β2|ₘₐₓ≦0.5·βₘₐₓ+x°, (5)
wherein x° is a first prescribed value which is a positive value being equal to or smaller than 0.5·βₘₐₓ and smaller than 5°, preferably smaller than 4°, more preferably smaller than 3°, in particular preferably smaller than 2°, more particular preferably smaller than 1°.

6. The fluid cylinder (100) of claim 5, wherein
the maximum of the second angle β1ₘₐₓ and the maximum of the fourth angle β2ₘₐₓ are adapted to fulfil
βₘₐₓ=y°, (6)
wherein y° is a second prescribed value being in a range of from 5° to 15°, preferably 7° to 13°, more preferably 9° to 11°, and further more preferably 9.4° to 10.6°.

7. The fluid cylinder (100) of claim 5, wherein
the driving member (60) comprises a piston rod (60rd),
the piston rod (60rd) comprises a first rod end (60rde1) coupled to the piston (30),
the piston rod (60rd) extends from the first rod end (60rde1) in the first axial direction (A1) and terminates at a second rod end (60rde2),
the second rod end (60rde2) is adapted to move along a closed orbit (Oc) so as to drive the piston (30) to fulfil equations (1) to (6), the closed orbit (Oc) extending in both the axial direction and the radial direction,
the closed orbit (Oc) has a first outmost point (Po1) in the first radial direction R1 in view of the tube axis (a) and a second outmost point (Po2) in the second radial direction (R2) in view of the tube axis (a), and
the maximum of the second angle β1ₘₐₓ is formed when the second rod end (60rde2) arrives at the first outmost point (Po1), while the maximum of the fourth angle β₂ₘₐₓ is formed when the second rod end (60rde2) arrives at the second outmost point (Po2).

8. The fluid cylinder (100) of claim 7, wherein
the closed orbit (Oc) is located within the reference plan (PL).

9. The fluid cylinder (100) of claim 7, wherein
the driving member (60) comprises a rotatable member (60rm) coupled to the second rod end (60rde2), and
the rotatable member (60rm) is adapted to rotate so as to move the second rod end (60rde2) along the closed orbit (Oc).

10. The fluid cylinder (100) of claim 9, wherein
the rotatable member (60rm) is adapted to form the closed orbit (Oc) in a circular shape.

11. The fluid cylinder (100) of claim 10, wherein
a circle center (C) of the closed orbit (Oc) is arranged on the tube axis (a), and
the first angle α is larger than 0°.

12. The fluid cylinder (100) of claim 11, wherein
the circle center (C) of the closed orbit (Oc) is arranged to shift from the tube axis (a) in the first radial direction (R1).

13. The fluid cylinder (100) of claim 11, wherein
the rotatable member (60rm) is a gear set (60rg) driven by a motor (60m), or
the rotatable member (60rm) is a rotatable rod (60rr) driven by a motor (60m).

14. The fluid cylinder of claim 7, wherein
the rotable member (60rm) is adapted to form the closed orbit (Oc) in a non-circular shape.

15. The fluid cylinder (100) of claim 1, wherein
the cylinder tube (10) comprises an expanded part (10ep) arranged at the first tube end (E1) and at least a part of the inner wall (50) of the expanded part (10ep) is expanded in a radial direction perpendicular to the tube axis (a), and
the driving member (60) is adapted to drive the piston (30) in the first axial direction (A1) to reach the expanded part (10ep) so as to remove at least a part of the fluid-tight sealing.

16. The fluid cylinder (100) of claim 1, wherein
the first tube end (E1) and the sealing member (40) are adapted, when the piston (30) is driven to the first tube end (E1), to enable at least a part of the sealing member (40) to be outside of the cylinder tube (10) so as to remove at least a part of the fluid-tight sealing.

17. The fluid cylinder (100) of anyone of claims 1 to 11, 15 and 16, wherein
the second tube end (E2) is a closed end and provided with a fluid outlet valve (Vout), wherein the fluid outlet valve (Vout) is a unidirectional valve for releasing fluid to the outside of the cylinder tube (10).

18. The fluid cylinder (100) of anyone of claims 1 to 11, 15 and 16, wherein
the fluid cylinder (100) is a gas cylinder (200) and the fluid-tight sealing is a gas-tight sealing.

19. The fluid cylinder (100) of claim 17, wherein
the fluid cylinder (100) is a gas cylinder (200), the fluid-tight sealing is a gas-tight sealing, and the fluid outlet valve (Vout) is a gas outlet valve.

20. A gas compressor (1000), comprising the gas cylinder (200) of claim 19.
